(19) United States
(12) Patent Application Publication
(10) Pub. No.: US 2008/0119383 A1
(43) Pub. Date: May 22, 2008

(54) Fabric treatment method and composition to impart differential Hydrophobicity

(76) Inventors: Christopher Boardman, Bebington (GB); Kenneth Stuart Lee, Bebington (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 11/983,934

(22) Filed: Nov. 13, 2007

(30) Foreign Application Priority Data
Nov. 17, 2006 (GB) 0623004.9

(51) Int. Cl. C11D 3/22

(52) U.S. Cl. 510/521

(57) ABSTRACT

A fabric softening composition comprising a fabric softening compound and from 5 to 50% by weight, preferably 5 to 25% by weight of the composition of a material (HH material) capable of changing its hydrophobic/hydrophilic properties in response to an activation step.

### TECHNICAL FIELD

This invention relates to a method of treating a fabric with a rinse conditioner composition and thereafter subjecting a portion of the fabric to an activation step to cause differential hydrophobicity, encouraging transport of water through the fabric. In one aspect the invention relates to compositions for use in such a method.

### BACKGROUND AND PRIOR ART

The uncomfortable feel of clothes associated with perspiration can take one of two forms depending on the level of sweat production. Under conditions of high sweat production, clothes can become saturated with sweat. Damp areas of clothing then contact the skin causing discomfort through local cooling and cling.

Under conditions of low sweat production there is sweat/high humidity in any space between the skin and first layer of clothing and within the clothing immediately adjacent the skin. Water vapour will gradually diffuse through the clothing into the surrounding air.

The textile literature identifies a high humidity level in the space between the skin and the first layer of clothing as one of the key drivers of discomfort under ambient, low exercise conditions. Similarly, discomfort can arise from the build up of liquid water on the inside surface of apparel textiles. A known approach to this problem is to increase the rate of liquid water transport through textile by increasing the rate of wicking or wetting. This is achieved by decreasing the contact angle of water on the fibre surface. This approach has the disadvantage of also increasing the total amount of water held in the textile. This leads to increased thermal conductivity and increased cling when these areas touch the skin. Both of these effects increase the discomfort experienced in wear.

It is known that certain materials, such as Zinc Oxide (ZnO) and Titanium Oxide (TiO₂) have the ability to change between hydrophobic and hydrophilic properties under different environmental conditions, see for example J. Am. Chem. Soc 2004, 126, 62-63 and Soft Matter 2005, 1, 55-61. There are various publications describing the effect of ZnO and TiO₂ as hydrophobic/hydrophilic switchable surfaces. WO2004108846 describes the use of TiO₂ as a coating in combination with a siloxane for an easy clean surface and discloses that it can be applied to fabrics. US2005/0186871 A1 discloses a gas permeable apparatus comprising a structure including a plurality of surfaces, at least another of the surfaces comprising electrets, at least one light source for exposing the at least one of the surfaces comprising the photocatalyst to light photons sufficient to activate the photocatalyst, the structure allowing for filtering particulates, wicking liquids, disinfecting, and deodarizing the surfaces.

Photocatalysts such as TiO₂ are incorporated into the surfaces of apparel products such as goggles to decompose and oxidize absorbed chemicals on the photocatalyst surfaces with absorption of light with sufficient energy to generate and electron hole pair in the photocatalyst. The electron hole pair leads to decomposition on surface contact with water and subsequent reactive chemicals on the surface of the photocatalysts. The coated surfaces also can function as air filters, air vents, wicking surfaces, protective covers, layers, over underlying materials, and act as ultraviolet light protective filters for the underlying materials and body.

The invention provides a method and composition for treating fabric with a rinse conditioner to increase transport of water through the fabric.

### SUMMARY OF THE INVENTION

According to one aspect of the invention there is provided a fabric softening composition comprising a fabric softening compound and from 5 to 50% by weight, preferably 5 to 25% by weight of the composition of a material (HH material) capable of changing its hydrophobic/hydrophilic properties in response to an activation step.

According to a further aspect of the invention there is provided a method of treating a fabric to enhance the transport of water or water vapour therethrough, the method comprising rinsing the fabric in a composition as described above to deposit fabric conditioner and HH material thereon, drying the fabric and before, after or simultaneously with the drying, subjecting a portion of the fabric to an activation step to cause HH material deposited in said portion to undergo a change in its hydrophobic/hydrophilic properties.

The idea of the invention is to reduce the level of water held in the region of the textile next to the skin, at the same time as facilitating the movement of water through the textile. This is achieved by creating different surface properties on fibres in different regions of the textile (either different regions of the garment, or different sides of the textile). Areas of the textile which are close to the skin are made hydrophobic, while the areas of the textile which are away from the skin are made hydrophilic. In this manner it is possible to increase water transport without increasing the water holding properties of the textile. Increasing water transport while also decreasing the amount of water held at the surface of the textile closest to the skin provides a beneficial effect. It is possible to maintain comfort for the wearer under conditions of low sweat production i.e. under low exercise conditions, with warm climate etc, or at least delay the outset of discomfort when the wearer is exposed to such conditions.

The key to this approach is to generate different local fibre properties following uniform treatment of the textile with a laundry product. By depositing the HH material onto the textile from the laundry treatment, areas which are close to the skin can be made hydrophobic, whereas areas of textile away from the skin may be rendered hydrophilic by an activation step. It is preferred the activation step uses local environmental conditions. For example, in a preferred embodiment the HH material is photosensitive and the outside of the garment is exposed to light, particularly UV light, and is rendered hydrophilic, whilst the inside of the garment close to the skin and therefore shielded from the sunlight remains hydrophobic.

Hydrophobic/Hydrophilic Material

In principle any material which can be deposited on a fabric from a rinse conditioner which can “switch” properties from hydrophobic to hydrophilic or visa versa upon exposure to certain conditions may be employed in the invention. The activation step causing the switch in properties may be based upon photosensitivity, pH change, temperature change, heat flow, change in ionic strength, enzymatic activity etc. The most convenient activation step is based upon photosensitivity, particularly UV light, since it is readily possible to expose the outside of a garment to sunlight, during wear and or drying, whilst shielding the inside of the garment.

Preferred HH materials are ZnO and TiO₂ which can be drawn from a range of morphologies, shapes and aspect ratios. Particle linear dimensions should be in the range of 1 nm to 1000 nm.—Other suitable photosensitive materials include those which undergo:
1) structural rearrangement to increase hydrophilicity (e.g. Ketoenol tautomerism or cis-trans isomerism resulting in breaking intra-molecular hydrogen bonds and favouring inter-molecular hydrogen bonds); or
2) degradation to more polar species (e.g. UV unstable dyes, or sunscreens).

The HH materials are generally deposited to apply from 0.2 to 1%, preferably 0.2 to 0.5% by weight of the fabric after drying. The HH materials are generally present in an amount of from 5 to 50%, preferably 5 to 25% by weight of the fabric softening composition.

Fabric Softening Compound

The fabric softening compound is preferably different from the HH material. Suitable fabric softening compounds are described below.

i) Oily Sugar Derivative

The oily sugar derivative is a liquid or soft solid derivative of a cyclic polyol or of a reduced saccharide, said derivative resulting from 35 to 100% of the hydroxyl groups in said polyol or in said saccharide being esterified or etherified. The derivative has two or more ester or ether groups independently attached to a C₈-C₂₂ alkyl or alkenyl chain.

The oily sugar derivatives of the invention are also referred to herein as “derivative-CP” and “derivative-RS” dependent upon whether the derivative is a product derived from a cyclic polyol or from a reduced saccharide starting material respectively.

Preferably the derivative-CP and derivative-RS contain 35% by weight tri or higher esters, e.g. at least 40%.

Preferably 35 to 85% most preferably 40 to 80%, even more preferably 45 to 75%, such as 45 to 70% of the hydroxyl groups in said cyclic polyol or in said reduced saccharide are esterified or etherified to produce the derivative-CP and derivative-RS respectively.

For the derivative-CP and derivative-RS, the tetra, penta etc prefixes only indicate the average degrees of esterification or etherification. The compounds exist as a mixture of materials ranging from the monoester to the fully esterified ester. It is the average degree of esterification as determined by weight that is referred to herein.

The derivative-CP and derivative-RS used do not have substantial crystalline character at 20° C. Instead they are preferably in a liquid or soft solid state, as hereinbelow defined, at 20° C.

The starting cyclic polyol or reduced saccharide material is esterified or etherified with C₈-C₂₂ alkyl or alkenyl chains to the appropriate extent of esterication or etherification so that the derivatives are in the requisite liquid or soft solid state. These chains may contain unsaturation, branching or mixed chain lengths.

Typically the derivative-CP or derivative-RS has 3 or more, preferably 4 or more, for example 3 to 8, e.g. 3 to 5, ester or ether groups or mixtures thereof. It is preferred if two or more of the ester or ether groups of the derivative-CP and derivative-RS are independently of one another attached to a C₈ to C₂₂ alkyl or alkenyl chain. The alkyl or alkenyl groups may be branched or linear carbon chains.

The derivative-CPs are preferred for use as the oily sugar derivative. Inositol is a preferred cyclic polyol, and Inositol derivatives are especially preferred.

In the context of the present invention the terms derivative-CP and derivative-RS encompass all ether or ester derivatives of all forms of saccharides, which fall into the above definition, and are especially preferred for use. Examples of preferred saccharides for the derivative-CP and derivative-RS to be derived from are monosaccharides and disaccharides.

Examples of monosaccharides include xylose, arabinose, galactose, fructose, sorbose and glucose. Glucose is especially preferred. An example of a reduced saccharide is sorbitan. Examples of disaccharides include maltose, lactose, cellobiose and sucrose. Sucrose is especially preferred.

If the derivative-CP is based on a disaccharide it is preferred if the disaccharide has 3 or more ester or ether groups attached to it. Examples include sucrose tri, tetra and penta esters.

Where the cyclic polyol is a reducing sugar it is advantageous if each ring of the derivative-CP has one ether group, preferably at the C₁ position. Suitable examples of such compounds include methyl glucose derivatives.

Examples of suitable derivative-CPs include esters of alkyl(poly)glucosides, in particular alkyl glucoside esters having a degree of polymerisation from 1 to 2.

The HLB of the derivative-CP and derivative-RS is typically between 1 and 3.

The derivative-CP and derivative-RS may have branched or linear alkyl or alkenyl chains (of varying degrees of branching), mixed chain lengths and/or unsaturation. Those having unsaturated and/or mixed alkyl chain lengths are preferred.

One or more of the alkyl or alkenyl chains (independently attached to the ester or ether groups) may contain at least one unsaturated bond.

For example, predominantly unsaturated fatty chains may be attached to the ester/ether groups, e.g. those attached may be derived from rape oil, cotton seed oil, soybean oil, oleic, tallow, palmitoleic, linoleic, erucic or other sources of unsaturated vegetable fatty acids.

The alkyl or alkenyl chains of the derivative-CP and derivative-RS are preferably predominantly unsaturated, for example sucrose tetratallowate, sucrose tetrarapeate, sucrose tetraoleate, sucrose tetraesters of soybean oil or cotton seed oil, cellobiose tetraoleate, sucrose trioleate, sucrose triapeate, sucrose pentaoleate, sucrose pentarapeate, sucrose hexaoleate, sucrose hexarapeate, sucrose triesters, pentaesters and hexaesters of soybean oil or cotton seed oil, glucose trioleate, glucose tetraoleate, xylose trioleate, or sucrose tetra-,tri-, penta-or hexa-esters with any mixture of predominantly unsaturated fatty acid chains.

However some derivative-CPs and derivative-RSs may be based on alkyl or alkenyl chains derived from polyunsaturated fatty acid sources, e.g. sucrose tetralinoleate. It is preferred that most, if not all, of the polyunsaturation has been removed by partial hydrogenation if such polyunsaturated fatty acid chains are used.

The most highly preferred liquid derivative-CPs and derivative-RSs are any of those mentioned in the above three paragraphs but where the polyunsaturation has been removed through partial hydrogenation.

Especially good results are obtained when the alkyl and/or alkenyl chains of the derivative-CPs and derivative-RSs are obtained by using a fatty acid mixture (to react with the starting cyclic polyol or reduced saccharide) which comprises a mixture of tallow fatty acid and oleyl fatty acid in a weight ratio of 10:90 to 90:10, more preferably 25:75 to 75:25, most preferably 30:70 to 70:30. A fatty acid mixture comprising a mixture of tallow fatty acid and oleyl fatty acid in a weight ratio of 60:40 to 40:60 is most preferred.

Especially preferred are fatty acid mixtures comprising a weight ratio of approximately 50 wt % tallow chains and 50 wt % oleyl chains. It is especially preferred that the fatty acid mixture consists only of a mixture of tallow fatty acid and oleyl fatty acid.

Preferably 40% or more of the chains contain an unsaturated bond, more preferably 50% or more, most preferably 60% or more e.g. 65% to 95%.

Other oily sugar derivatives suitable for use in the compositions include sucrose pentalaurate, sucrose pentaerucate and sucrose tetraerucate. Suitable materials include some of the Ryoto series available from Mitsubishi Kagaku Foods Corporation.

The liquid or soft solid derivative-CPs and derivative-RSs are characterised as materials having a solid: liquid ratio of between 50:50 and 0:100 at 20° C. as determined by T₂ relaxation time NMR, preferably between 43:57 and 0:100, most preferably between 40:60 and 0:100, such as, 20:80 and 0:100. The T₂ NMR relaxation time is commonly used for characterising solid:liquid ratios in soft solid products such as fats and margarines. For the purpose of the present invention, any component of the NMR signal with a T₂ of less than 100 microsecond is considered to be a solid component and any component with T₂ greater than 100 microseconds is considered to be a liquid component.

The liquid or soft solid derivative-CPE and derivative-RSE can be prepared by a variety of methods well known to those skilled in the art. These methods include acylation of the cyclic polyol or of a reduced saccharide with an acid chloride; trans-esterification of the cyclic polyol or of a reduced saccharide material with short chain fatty acid esters in the presence of a basic catalyst (e.g. KOH); acylation of the cyclic polyol or of a reduced saccharide with an acid anhydride, and, acylation of the cyclic polyol or of a reduced saccharide with a fatty acid. Typical preparations of these materials are disclosed in U.S. Pat. No. 4,386,213 and AU 14416/88 (Procter and Gamble).

When an oily sugar derivative is present the compositions preferably comprise between 0.5%-30% wt of the oily sugar derivatives, more preferably 1-20% wt, most preferably 1.5-20% wt, e.g. 3-15% wt %, based on the total weight of the composition.

(ii) Cationic Fabric Softening Compounds

The preferred cationic fabric softening compound(s) are those having two or more alkyl or alkenyl chains each having an average chain length equal to, or greater than C₈, especially C₁₂₋₂₈ alkyl or alkenyl chains connected to a nitrogen atom. The alkyl or alkenyl groups are preferably connected via at least one ester link, more preferably via two or more ester linkages.

The cationic fabric softening compounds may be ester-linked quaternary ammonium fabric softening compounds or non-ester linked quaternary ammonium fabric softening compounds. The ester-linked quaternary ammonium fabric softening compounds are herein referred to as “the ester-softening compound”. The non-ester linked quaternary ammonium fabric softening compounds are herein referred to as “the non-ester softening compound”.

Especially suitable compounds have two or more alkyl or alkenyl chains each having an average chain length equal to, or greater than C₁₄, more preferably, equal to or greater C₁₆. Most preferably at least 50% of the total number of alkyl or alkenyl chains have a chain length equal to, or greater than C₁₈.

It is advantageous for environmental reasons if the ester-softening compound is biologically degradable. It is also preferred if the alkyl or alkenyl chains of the ester-softening compound are predominantly linear.

One preferred type of ester-softening compound is a quaternary ammonium material represented by formula (I):

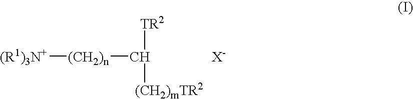

wherein T is

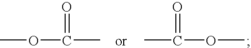

each R¹ group is independently selected from C₁₋₄, alkyl or hydroxyalkyl or C₂₋₄ alkenyl groups; and wherein each R² group is independently selected from C₈₋₂₈ alkyl or alkenyl groups, X⁻ is any suitable anion including a halide, acetate or lower alkosulphate ion, such as chloride or methosulphate, n is O or an integer from 1-5, and m is from 1-5.

Preferred materials of this class such as 1,2 bis[hardened tallowoyloxy]-3-trimethylammonium propane chloride and their method of preparation are, for example, described in U.S. Pat. No. 4,137,180 (Lever Brothers). Preferably these materials comprise small amounts of the corresponding monoester as described in U.S. Pat. No. 4,137,180 for example 1-hardened tallowoyloxy -2-hydroxy 3-trimethylammonium propane chloride.

A second preferred type of ester-softening compound is represented by the formula (II):

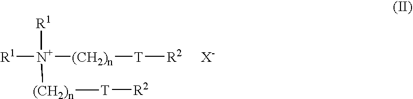

wherein T, R¹, R², n, and X⁻ are as defined above.

In this class di(tallowoyloxyethyl) dimethyl ammonium chloride and methyl bis-[ethyl(tallowoyl)]-2-hydroxyethyl ammonium methyl sulphate are especially preferred. The tallow chains in these compounds may be hardened and may even be fully unsaturated, i.e. preferred compounds also include di(hardened tallowoyloxy ethyl) dimethyl ammonium chloride and methyl bis-[ethyl(hardened tallowoyl)]-2-hydroxyethyl ammonium methyl sulphate. Commercially available compounds include those in the Tetranyl range (ex Kao) and Stepantex range (ex Stepan).

Also suitable are derivatives of the above formula where one or more of the (CH₂)ₙ chain(s) has at least one pendent alkyl chain e.g. a methyl chain. Examples include the cationic quaternary ammonium compounds described in WO 99/35223 and WO 99/35120 (Witco).

Another preferred softening active is triethanolamine di-alkylester methosulphate (TEAQ). The iodine value of the parent fatty acid is preferably in the range of from 20 to 60, more preferably from 25 to 50, still more preferably from 30 to 45, and most preferably from 30 to 42. Preferred mono-: di-: tri-ester distribution ratios of these materials are in the range as follows:—

Mono: from 28 to 42%, preferably 30 to 40%, most preferably 30 to 35%

Di: from 45 to 60%, preferably 50 to 55%

Tri: from 5 to 25%, preferably 5 to 15%, most preferably from 6 to 10%.

A third preferred type of ester-softening compound is a quaternary ammonium material represented by the formula (III):

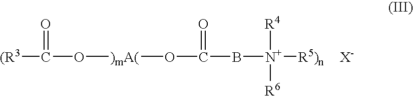

wherein X⁻ is as defined above, A is an (m+n) valent radical remaining after the removal of (m+n) hydroxy groups from an aliphatic polyol having p hydroxy groups and an atomic ratio of carbon to oxygen in the range of 1.0 to 3.0 and up to 2 groups per hydroxy group selected from ethylene oxide and propylene oxide, m is 0 or an integer from 1 to p-n, n is an integer from 1 to p-m, and p is an integer of at least 2, B is an alkylene or alkylidene group containing 1 to 4 carbon atoms, R³, R⁴, R⁵ and R⁶ are, independently from each other, straight or branched chain C₁-C₄₈ alkyl or alkenyl groups, optionally with substitution by one or more functional groups and/or interruption by at most 10 ethylene oxide and/or propylene oxide groups, or by at most two functional groups selected from;

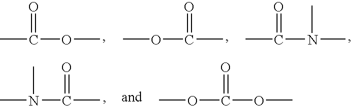

or R⁴ and R⁵ may form a ring system containing 5 or 6 atoms in the ring, with the proviso that the average compound either has at least one R group having 22-48 carbon atoms, or at least two R groups having 16-20 carbon atoms, or at least three R groups having 10-14 carbon atoms. Preferred compounds of this type are described in EP 638 639 (Akzo).

The non-ester softening compound preferably has the alkyl or alkenyl chain lengths referred to above (in respect of the non-ester softening compounds).

One preferred type of non-ester softening compound is a quaternary ammonium material represented by formula (IV):

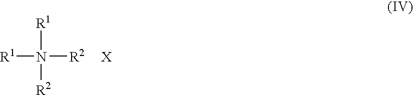

wherein each R¹ group is independently selected from C₁₋₄ alkyl, hydroxyalkyl or C₂₋₄ alkenyl groups; each R² group is independently selected from C₈₋₂₈ alkyl or alkenyl groups, and X⁻ is as defined above.

A preferred material of formula (IV) is di-hardened tallow-dimethyl ammonium chloride, sold under the Trademark ARQUAD 2HT by Akzo Nobel.

The compositions preferably comprise a total amount of between 0.5% wt-30% by weight of the cationic fabric softening compounds, preferably 1%-25%, more preferably 1.5-22%, most preferably 2%-20%, based on the total weight of the composition.

Non-Ionic Surfactant

A non-ionic surfactant may be present in order to stabilise the composition, or perform other functions such as emulsifying any oil that may be present.

Suitable non-ionic surfactants include alkoxylated materials, particularly addition products of ethylene oxide and/or propylene oxide with fatty alcohols, fatty acids and fatty amines.

Preferred materials are of the general formula:

R—Y—(CH₂CH₂O)_{z}H

Where R is a hydrophobic moiety, typically being an alkyl or alkenyl group, said group being linear or branched, primary or secondary, and preferably having from 8 to 25, more preferably 10 to 20, and most preferably 10 to 18 carbon atoms; R may also be an aromatic group, such as a phenolic group, substituted by an alkyl or alkenyl group as described above; Y is a linking group, typically being O, CO.O, or CO.N (R¹), where R¹ is H or a C₁₋₄ alkyl group; and z represents the average number of ethoxylate (EO) units present, said number being 8 or more, preferably 10 or more, more preferably 10 to 30, most preferably 12 to 25, e.g. 12 to 20.

Examples of suitable non-ionic surfactants include the ethoxylates of mixed natural or synthetic alcohols in the “coco” or “tallow” chain length. Preferred materials are condensation products of coconut fatty alcohol with 15-20 moles of ethylene oxide and condensation products of tallow fatty alcohol with 10-20 moles of ethylene oxide.

The ethoxylates of secondary alcohols such as 3-hexadecanol, 2-octadecanol, 4-eicosanol, and 5-eicosanol may also be used. Exemplary ethoxylated secondary alcohols have formulae C₁₂-EO(20); C₁₄-EO(20); C₁₄-EO(25); and C₁₆-EO(30). Especially preferred secondary alcohols are disclosed in PCT/EP2004/003992 and include Tergitol-15-S-3.

Polyol-based non-ionic surfactants may also be used, examples including sucrose esters (such as sucrose monooleate), alkyl polyglucosides (such as stearyl monoglucoside and stearyl triglucoside), and alkyl polyglycerols.

Fatty Complexing Agent

A preferred additional component in the compositions of the present invention is a fatty complexing agent. Such agents typically have a C₈ to C₂₂ hydrocarbyl chain present as part of their molecular structure. Suitable fatty complexing agents include C₈ to C₂₂ fatty alcohols and C₈ to C₂₂ fatty acids; of these, the C₈ to C₂₂ fatty alcohols are most preferred. A fatty complexing agent is particularly valuable in compositions comprising a QAC having a single C₁₂₋₂₈ group connected to the nitrogen head group, such as mono-ester associated with a TEA ester quat. or a softening agent of formula II, for reasons of product stability and effectiveness.

Preferred fatty acid complexing agents include hardened tallow fatty acid. (available as Pristerene, ex Uniqema).

Preferred fatty alcohol complexing agents include C₁₆/C₁₈ fatty alcohols (available as Stenol and Hydrenol, ex Cognis, and Laurex CS, ex Albright and Wilson) and behenyl alcohol, a C₂₂ fatty alcohol, available as Lanette 22, ex Henkel.

The fatty complexing agent may be used at from 0.1% to 10%, particularly at from 0.2% to 5%, and especially at from 0.4 to 2% by weight, based on the total weight of the composition.

Perfume

The compositions of the invention typically comprise one or more perfumes. The perfume is preferably present in an amount from 0.01 to 10% by weight, more preferably 0.05 to 5% by weight, most preferably 0.5 to 4.0% by weight, based on the total weight of the composition.

Viscosity Modifiers

The Fabric softening compositions may comprise viscosity modifiers. Suitable viscosity modifiers are disclosed, for example, in WO 02/081611, US 2004/0214736, U.S. Pat. No. 6,827,795, EP 0501714, US 2003/0104964, EP 0385749 and EP 331237.

Further Optional Ingredients

The compositions of the invention may contain one or more other ingredients. Such ingredients include preservatives (e.g. bactericides), pH buffering agents, perfume carriers, fluorescers, colourants, hydrotropes, antifoaming agents, anti-redeposition agents, soil-release agents, electrolytes including polyelectrolytes, enzymes, optical brightening agents, anti-shrinking agents, anti-wrinkle agents, anti-spotting agents, anti-oxidants, sunscreens, anti-corrosion agents, drape imparting agents, anti-static agents, ironing aids and dyes.

Product Use

The compositions of the present invention are preferably rinse conditioner compositions and may be used in the rinse cycle of a domestic laundry process.

The composition is preferably used in the rinse cycle of a home textile laundering operation, where, it may be added directly in an undiluted state to a washing machine, e.g. through a dispenser drawer or, for a top-loading washing machine, directly into the drum. Alternatively, it can be diluted prior to use. The compositions may also be used in a domestic hand-washing laundry operation.

It is also possible, though less desirable, for the compositions of the present invention to be used in industrial laundry.

The invention will be described with reference to the following Example.

### EXAMPLE

Apparatus

Pad Mangle: Vertical laboratory padder VFM type ex. Werner Mathis AG

Darkened Drying frame

Light Source: Atlas Xenon Weatherometer S3000

Bottle roller: Stuart Scientific Roller mixer SRT1

Spin dryer: Creda debonair spindryer

Materials

Fabric: 100% Polyester (Plain weave 122 gm-⁻²)
100% Polyester (Knit 140 gm-⁻²)
100% cotton (jersey knit (175 gm-⁻²)

Treatments: ZnO nanopowder (ex. Sigma Aldrich)
TiO₂ nanopowder (ex. Sigma Aldrich)

Fabric Softener Composition 1

| | |
|---|---|
| TiO₂ | 50.00 |
| Cationic Fabric Softener (Stepantex UL 85) | 6.34 |
| Nonionic (Genapol C200) | 0.19 |
| Tallow alcohol (Stenol 1618) | 0.50 |
| Perfume | 0.47 |
| Water | 42.50 |

Procedure

Treatment

Samples of clean polyester or cotton were cut into 20 cm×10 cm pieces

Fabric samples were treated with prototypes using a pad mangle or a bottle roller

Padded Samples

ZnO and TiO₂ were each diluted to make a 1.0% w/w dispersion for pad application.

These 1.0% dispersions were pad applied to the polyester at 100% pick-up.

This evenly delivered 1% on weight of fabric (o.w.f.) of the metal oxide to the fabric

The Fabric Softener Composition 1 was diluted to make a 25% w/w dispersion for further dilution

This 25% dispersion was diluted to make 2% w/w dispersion for pad application.

The 2% w/w dispersion was pad applied to the knitted cotton at 100% pick-up.

This evenly delivered 1.0% o.w.f. of the metal oxide and 0.12% o.w.f. of standard rinse conditioner active to the fabric.

Exhausted Sample

The Fabric Softener Composition 1 was diluted to make a 25% w/w dispersion for further dilution.

This 25% dispersion was diluted to make 0.25% w/w dispersion for exhaust application.

The 0.25% w/w dispersion placed in a bottle with a fabric sample.

The bottle was rolled for 10 minutes to allow deposition to take place.

The fabric sample was then spun for 1 minute in a domestic spin dryer.

This delivered 1.0% o.w.f. of the metal oxide and 0.12% o.w.f. of standard rinse conditioner active to the fabric if 100% of the material is deposited.

The treated fabric samples were allowed to dry in air within a darkened drying frame.

Light Exposure

The treated dried samples were then cut in half with half staying in the darkened drying frame.

The other half were placed in the Atlas weatherometer mounting frames ready for light exposure.

The fabric samples were then exposed to a 2 kW Xenon light source for 3 hours with a relative humidity between 60-80%. Once the exposure was complete the polyester samples were assessed for their wetting behaviour.

Wetting Test

Exposed and unexposed samples were assessed for wetting.

Several 50 μl droplets were placed across the surface of the fabric and the time taken from the droplets to fully penetrate the surface was measured. This was completed on both sides of the knitted polyester.

Results

Result shown as time taken to wet the surface against treatment.

Woven Polyester

| | Wetting Time |
|---|---|
| Treatments | (seconds) |
| 1% ZnO | 600+ |
| 1% ZnO + UV exposure | 0 |
| 1% TiO₂ | 600+ |
| 1% TiO₂ + UV exposure | 0 |
| Untreated | 600+ |
| Untreated + UV exposure | 600+ |

Knitted Polyester

| | Wetting Time |
|---|---|
| Treatments | (seconds) |
| 1% TiO₂ | 600 |
| 1% TiO₂ + Light exposure | 0 |
| 1% TiO₂ + Light exposure (RS)* | 600 |
| Untreated | 600 |
| Untreated + Light exposure | 600 |

*(RS) Reverse side of exposed polyester

Knitted Cotton

| | Wetting |
|---|---|
| | Time |
| Treatments | (seconds) |
| Composition 1 Pad | 600+ |
| Composition 1 Pad + UV exposure | 0 |
| Composition 1 Pad + UV exposure (RS) | 600+ |
| Composition 1 Exhaust | 180 |
| Composition 1 Exhaust + UV exposure | 0 |
| Composition 1 Exhaust + UV exposure (RS) | 180 |
| Untreated | 0 |
| Untreated + UV exposure | 0 |

We claim:

1. A fabric softening composition comprising a fabric softening compound and from 5 to 50% by weight, preferably 5 to 25% by weight of the composition of a material (HH material) capable of changing its hydrophobic/hydrophilic properties in response to an activation step.

2. A fabric softening composition as claimed in claim 1 in which the HH material is hydrophobic but becomes hydrophilic upon exposure to light, particularly UV light.

3. A fabric softening composition as claimed in claim 2 in which the HH material comprises ZnO and/or TiO₂.

4. A fabric softening composition as claimed in claim 1 in which the HH material changes its hydrophobic/hydrophilic properties in response to change in pH, temperature change, heat flow, change in ionic strength or presence of an enzyme.

5. A composition as claimed in claim 1 in which the fabric conditioning composition is selected from an oily sugar derivative, a cationic fabric softening compound and mixture thereof.

6. A composition as claimed in claim 5 in which the cationic fabric softening compound is a quaternary ammonium compound having at least two C₁₂₋₂₈ groups connected to the nitrogen head group that may independently be alkyl or alkenyl groups, preferably being connected to the nitrogen head group by an ester link.

7. A composition as claimed in claim 1 which additionally comprises one or more ingredients selected from perfume, non-ionic surfactant, fatty acid, fatty alcohol and viscosity modifier.

8. A method of treating a fabric to enhance the transport of water or water vapour therethrough, the method comprising rinsing the fabric in a composition as claimed in claim 1 to deposit fabric conditioner and HH material thereon, drying the fabric and before, after or simultaneously with the drying, subjecting a portion of the fabric to an activation step to cause HH material deposited in said portion to undergo a change in its hydrophobic/hydrophilic properties.

9. A method as claimed in claim 8 in which the HH material is ZnO and/or TiO₂ and the activation step comprises exposure to UV light.

10. A method as claimed in claim 8 in which one side or portion of the fabric is subjected to said activation step.

11. A method as claimed in claim 9 in which one side or portion of the fabric is subjected to said activation step.
